(19) United States
(12) Patent Application Publication
(10) Pub. No.: US 2017/0043664 A1
(43) Pub. Date: Feb. 16, 2017

(54) VIDEO DISPLAY ON WINDSHIELD AND WINDOWS IN AUTONOMOUS CARS

(71) Applicant: Panasonic Automotive Systems Company of America, Division of Panasonic Corporation of North America, PEACHTREE CITY, GA (US)

(72) Inventor: SHANTHA KUMARI RAJENDRAN, FARMINGTON HILLS, MI (US)

(73) Assignee: Panasonic Automotive Systems Company of America, Division of Panasonic Corporation of North America

(21) Appl. No.: 15/235,244

(22) Filed: Aug. 12, 2016

Related U.S. Application Data
(60) Provisional application No. 62/204,231, filed on Aug. 12, 2015.

(51) Int. Cl. B60K 35/00; G02B 27/01

(52) U.S. Cl. CPC B60K 35/00; G02B 27/0101; G02B 2027/014; G02B 2027/0141; B60K 2350/921; B60K 2350/906; B60K 2350/2052

(57) ABSTRACT

A method is for presenting information to passengers within a vehicle having at least one sheet of transparent material associated with a passenger compartment of the vehicle. A first priority level is assigned to first infotainment content. The first infotainment content is displayed in association with the sheet of transparent material. A second priority level is assigned to second infotainment content. It is determined whether the second priority level is higher than the first priority level. If the second priority level is higher than the first priority level, then the displaying of the first infotainment content is ceased, and displaying of the second infotainment content in association with the sheet of transparent material is initiated. If the second priority level is not higher than the first priority level, then the displaying of the first infotainment content is continued.

### CROSS-REFERENCED TO RELATED APPLICATIONS

This application claims benefit of U.S. Provisional Application No. 62/204,231 filed on Aug. 12, 2015, which the disclosure of which is hereby incorporated by reference in its entirety for all purposes.

### FIELD OF THE INVENTION

The disclosure relates to a display system for a vehicle, and, more particularly, to a display system which may be presented on glass windows and the windshield of the vehicle.

### BACKGROUND OF THE INVENTION

It is known in vehicles for displays to be provided on the front dashboard, doors and rear panel. However, the available surface areas available for displays in these areas is limited.

### SUMMARY

The present invention may provide a display in a vehicle's windshield and window glasses, wherein an electronic controller controls the content of the display. The content can be in the form of entertainment/news video, external driving conditions, and/or infotainment messages. The controller can turn off the video/messages and make the display transparent so that the passengers of the vehicle can view the road. The turning on and turning off of the video/messages can be based on external driving conditions or a user request.

In one embodiment, the invention comprises a method for presenting information to passengers within a vehicle having at least one sheet of transparent material associated with a passenger compartment of the vehicle. A first priority level is assigned to first infotainment content. The first infotainment content is displayed in association with the sheet of transparent material. A second priority level is assigned to second infotainment content. It is determined whether the second priority level is higher than the first priority level. If the second priority level is higher than the first priority level, then the displaying of the first infotainment content is ceased, and displaying of the second infotainment content in association with the sheet of transparent material is initiated. If the second priority level is not higher than the first priority level, then the displaying of the first infotainment content is continued.

In another embodiment, the invention comprises a method of presenting information to passengers within a vehicle having at least one window formed of transparent material in addition to a front windshield. A user request to present first infotainment content is received, second content related to road conditions is received, or second content related to a condition of the vehicle is received. In response to the receiving step, the first infotainment content or the second content is displayed on the window or windshield.

In yet another embodiment, the invention comprises a motor vehicle including at least one side view window or windshield having a sheet of transparent material. A display control unit presents at least one image on the window or windshield. The display control unit includes a processor causing the display control unit to display first infotainment content on the window or windshield. The first infotainment content has a first priority level. The processor determines whether a second priority level of second infotainment content is higher than the first priority level. If the second priority level is higher than the first priority level, then the processor causes the display control unit to cease the displaying of the first infotainment content, and causes the display control unit to initiate displaying of the second infotainment content on the window or windshield. If the second priority level is not higher than the first priority level, then the processor causes the display control unit to continue the displaying of the first infotainment content.

The invention may have the advantage that passengers of the vehicle may not need to rely on smaller displays for viewing video or other information. Instead, passengers of the vehicle can take advantage of the wide screen area present on the windshield and other window areas. For example, side view windows may measure about fifteen inches by fifteen inches.

Yet another advantage is that users can have access to up to six individual and distinct display areas: the windshield, the rear window, and four side windows. Larger vehicles, such as minivans, can have more than six displays areas.

Still another advantage is that users can still use the glass on the windshield and the windows for viewing outside the vehicle in case of emergency or when desired.

### BRIEF DESCRIPTION OF THE DRAWINGS

A better understanding of the present invention will be had upon reference to the following description in conjunction with the accompanying drawings.

FIG. 1 is a block diagram of one embodiment of a windshield/window video display arrangement of the present invention.

FIG. 2 is a flow chart of one example embodiment of a vehicular video display method of the present invention.

FIG. 3 is a flow chart of another example embodiment of a vehicular video display method of the present invention.

FIG. 4 is a flow chart of yet another example embodiment of a vehicular video display method of the present invention.

FIG. 5 is a flow chart of a further example embodiment of a vehicular video display method of the present invention.

### DETAILED DESCRIPTION OF THE PREFERRED EMBODIMENTS

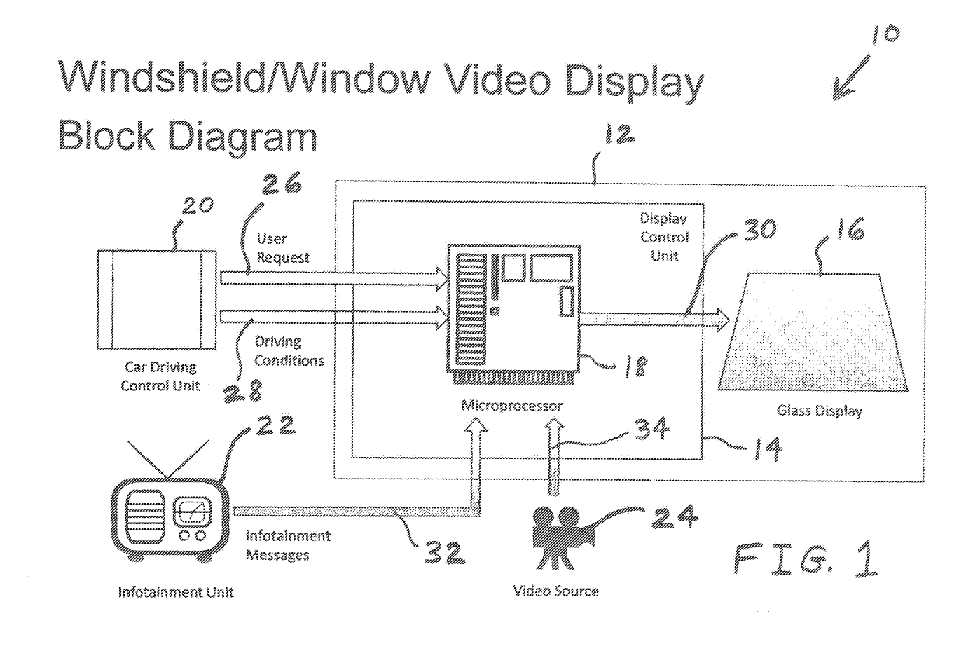

FIG. 1 illustrates one embodiment of a vehicular windshield/window video display arrangement 10 of the present invention, including a display system 12 having a display control unit 14 and a glass display 16, which may use hardware similar to the hardware used in head up displays, for example. Display control unit 14 includes a processor 18. Vehicular windshield/window video display arrangement 10 also includes a car driving control unit 20, an infotainment unit 22, and a video source 24.

During use, car driving control unit 20 may transmit a user request 26 or a command/information 28 related to driving conditions to processor 18. The user request 26 or command/information 28 may cause processor 18 to transmit digital image data or analog images 30 to glass display 16.

The transmission of command/information 28 may be triggered by environmental sensors on the vehicle. For example, a traction sensor may detect that the road being driven on has poor traction, such as due to the presence of ice, and it may be desirable to inform the driver of the poor conditions without the driver having to look away from the road. Consequently, infotainment unit 22 may transmit a warning message 32 about the poor traction conditions to processor 18, and driving control unit 20 may transmit a command 28 to processor 18, instructing processor 18 to present images related to the poor traction warning message 32 on the vehicle glass.

Alternatively, a rear seat passenger may decide that he would like to view some image or video on a rear seat side window. The rear seat passenger, or some other passenger or driver, may cause a user request 26 to be transmitted from car driving control unit 20 to processor 18. For example, the passenger may manually enter an input into a user interface (not shown) of car driving control unit 20, or may speak a voice command that is detected by a microphone (not shown) associated with car driving control unit 20. In response to receiving user request 26, processor 18 may cause a video 34 received from video source 24 to be presented on the rear seat side window.

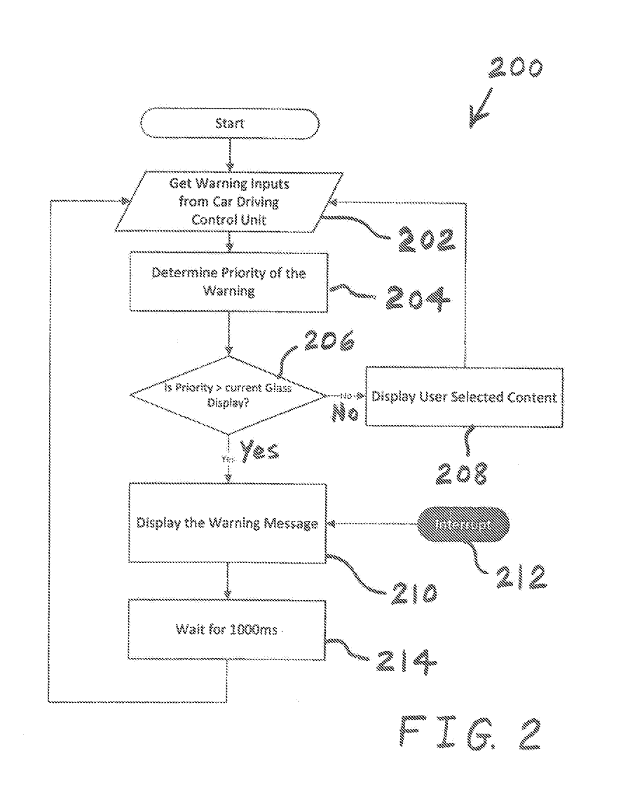

One embodiment of a vehicular video display method 200 of the present invention is illustrated in FIG. 2. In a first step 202, warning inputs are received from the car driving control unit. For example, car driving control unit 20 may transmit a warning 28 of icy road conditions to processor 18.

Next, in step 204, a priority level of warning 28 may be determined. That is, a priority level may be assigned to each message or content that may potentially be displayed on glass display 16. Typically, messages or content that are directed to safety issues are assigned higher priorities than are messages or content that are directed to entertainment because of the higher importance of safety issues.

In a next step 206, it is determined whether the priority level of warning 28 is greater than the priority level of the content that is currently being displayed on glass display 16. All content, including non-warning content, displayed on glass display 16 may be assigned a priority level. For example, content that a user has specifically requested (e.g., a specific movie) may be assigned a higher priority than content that the user has more generally selected for display (e.g., a type of content or a source of content), but that processor 18 has specifically chosen for display on glass display 16 (e.g., information about landmarks that are visible through the window or windshield on which the content is being displayed, wherein the landmarks are ascertained via a global positioning system).

If it is determined in step 206 that the priority level of warning 28 is not greater than the priority level of the content that is currently being displayed on glass display 16, then operation proceeds to step 208, where the content selected by the user is displayed on glass display 16 instead of a display associated with warning 28. Operation then returns to step 202.

Conversely, if it is determined in step 206 that the priority level of warning 28 is indeed greater than the priority level of the content that is currently being displayed on glass display 16, then operation proceeds to step 210, where content associated with warning 28 is displayed on glass display 16 instead of the content selected by the user.

It is also possible for processor 18 to decide to display the content associated with warning 28 on glass display 16 instead of the content selected by the user by issuing an interrupt 212 in the event that warning 28 is deemed to be important, but has not had a priority level pre-assigned to it. For example, an external source of warning content, such as a vehicle manufacturer or a government agency, may transmit an interrupt 212 in the form of a warning message to the vehicle, wherein the particular warning signal has not been assigned a priority. In this event, processor 18 may decide to display the content associated with the externally sourced warning signal on glass display 16 instead of the content selected by the user without first evaluating a priority level of the warning signal. Alternatively, interrupt 212 may be in the form of a user request for a specific and/or predetermined type of information to be displayed, such as, for example, the driving range of the vehicle with the amount of gasoline currently in the tank.

After the warning message has been displayed in step 210, one second of waiting occurs in step 214 before operation returns back to step 202.

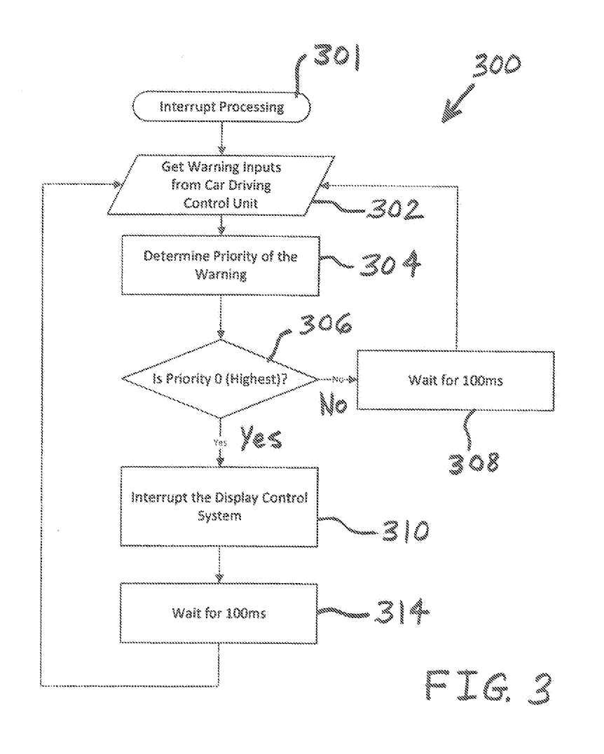

Another embodiment of a vehicular video display method 300 of the present invention is illustrated in FIG. 3. After interrupt processing occurs in step 301, in a next step 302, warning inputs are received from the car driving control unit. For example, car driving control unit 20 may transmit to processor 18 a warning 28 of a low oil level in the vehicle.

Next, in step 304, a priority level of warning 28 may be determined. That is, a priority level may be assigned to each message or content that is issued for display on glass display 16. Typically, messages or content that are directed to vehicle maintenance or vehicle operation issues are assigned higher priorities than are messages or content that are directed to entertainment because of the higher importance of operating the vehicle without excessive wear or damage.

In a next step 306, it is determined whether the priority level of warning 28 is the highest possible priority level. All content, including non-warning content, displayed on glass display 16 may be assigned a priority level. For example, content that is safety-related (e.g., low tire pressure) may be assigned a highest priority level, while non-safety related information and user-selected information/entertainment may be assigned a priority level that is lower than the highest priority level.

If it is determined in step 306 that the priority level of warning 28 is not the highest priority level, then operation proceeds to step 308, where 0.1 second of waiting occurs before operation returns to step 302. Conversely, if it is determined in step 306 that the priority level of warning 28 is indeed the highest priority level, then operation proceeds to step 310, where the display control system is interrupted. For example, the display of content currently being presented on glass display 16 is ceased, and content associated with warning 28 is displayed on glass display 16 instead of the currently presented content. After the content associated with warning 28 has been displayed in step 310, 0.1 second of waiting occurs in step 314 before operation returns back to step 302.

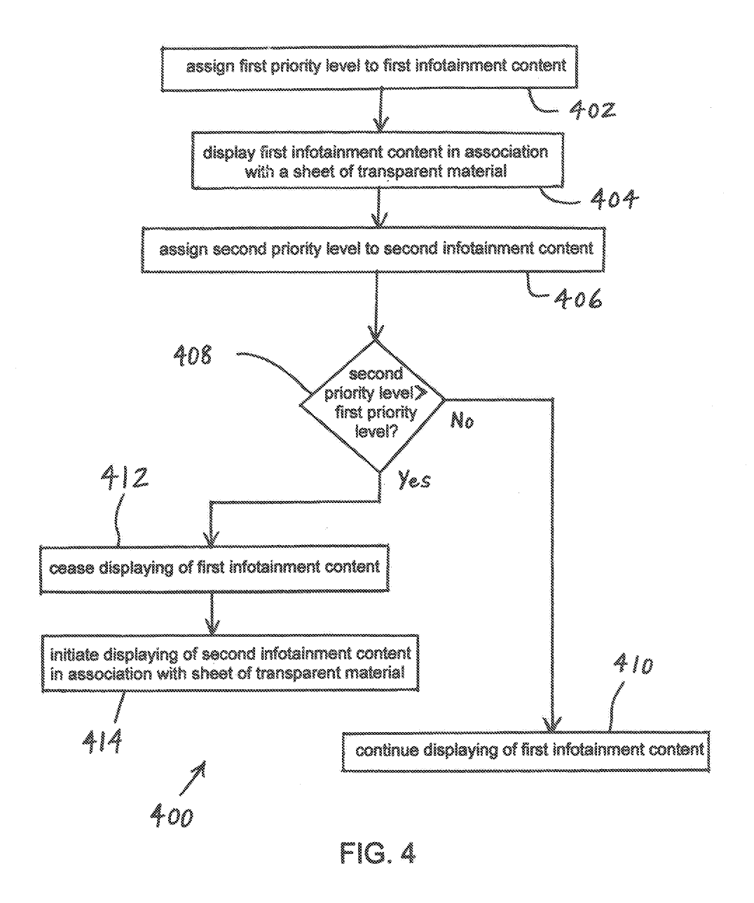

Another embodiment of a vehicular video display method 400 of the present invention is illustrated in FIG. 4. In a first step 402, a first priority level is assigned to first infotainment content. For example, the first infotainment content may be metadata associated with music that is being played on the radio, and may be assigned the lowest priority level because it is relatively unimportant.

In step 404, the first infotainment content is displayed in association with a sheet of transparent material. That is, the text metadata may be displayed on a side window of the vehicle.

Next, in step 406, a second priority level is assigned to second infotainment content. For example, the second infotainment content may be a measurement of some operating parameter of the vehicle. If the second infotainment content is non-safety-related, such as the current gas mileage of the vehicle, then it may be assigned the lowest priority level. On the other hand, if the second infotainment content is safety-related, such as a low pressure reading for one of the tires of the vehicle, then it may be assigned a priority level that is higher than the lowest priority level.

In step 408, it is determined whether the second priority level is higher than the first priority level. For example, if the second infotainment content is the current gas mileage of the vehicle, with the lowest priority level, then the second priority level may not be higher than the first priority level, and displaying of the first infotainment content is continued (step 410). On the other hand, if the second infotainment content is a low pressure reading for one of the tires, then the second priority level may be higher than the first priority level of the first infotainment content (e.g., the music metadata), and displaying of the first infotainment content is ceased (step 412). Finally, in step 414 displaying of the second infotainment content in association with the sheet of transparent material is initiated. That is, an indication of the low tire pressure reading may be displayed on the side window of the vehicle.

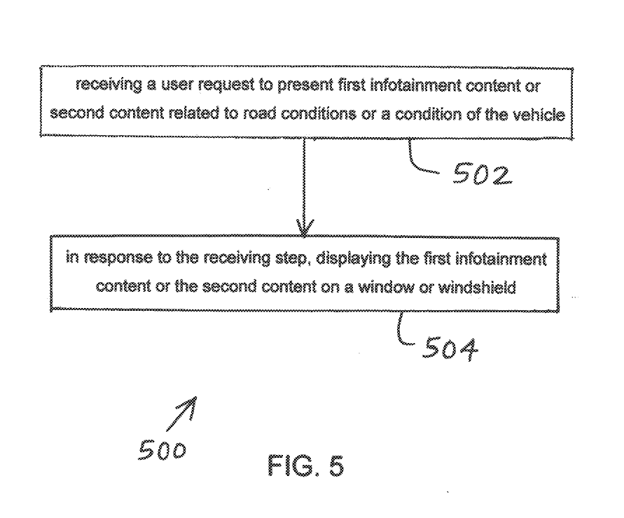

Another embodiment of a vehicular video display method 500 of the present invention is illustrated in FIG. 5. More particularly, method 500 may be a method of presenting information to passengers within a vehicle having at least one window formed of transparent material in addition to a front windshield. In a first step 502, received is either a user request to present first infotainment content, or second content related to road conditions or a condition of the vehicle. For example, the user may request that first infotainment content, such as an identification of a currently tuned-to radio station, be presented to him. Alternatively, second content, such as a warning of the road being icy, or a warning of the temperature of the engine being dangerously high, may be received by the vehicle infotainment system. The second content related to a condition of the vehicle may include information about the vehicle without relation to any external environment, and may exclude information related to an external environment, such as vehicle speed, which information is conventionally presented by a head up display. In a next step 504, in response to the receiving step 502, the first infotainment content or the second content is displayed on the window or windshield. That is, the first infotainment content requested by the user, or the second content received by the infotainment system, may be displayed on any window of the vehicle, or on the windshield.

Although a glass display has been described herein as being incorporated into a window or windshield, it is to be understood that it is within the scope of the invention for the glass display to be incorporated into a mirror or on any surface that may be covered by transparent material, such as glass or transparent plastic.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A method of presenting information to passengers within a vehicle having at least one sheet of transparent material associated with a passenger compartment of the vehicle, the method comprising the steps of:
assigning a first priority level to first infotainment content;
displaying the first infotainment content in association with the sheet of transparent material;
assigning a second priority level to second infotainment content;
determining whether the second priority level is higher than the first priority level;
if the second priority level is higher than the first priority level, then:
ceasing the displaying of the first infotainment content; and
initiating displaying of the second infotainment content in association with the sheet of transparent material; and
if the second priority level is not higher than the first priority level, then continuing the displaying of the first infotainment content.

2. The method of claim 1 wherein the sheet of transparent material comprises a pane of glass.

3. The method of claim 2, wherein the pane of glass is in a side view window or windshield of the vehicle.

4. The method of claim 1 wherein the second infotainment content is related to driving conditions of the environment in which the vehicle is disposed.

5. The method of claim 1 comprising the further steps of:
receiving a request from a user to display third infotainment content;
ceasing the displaying of the first infotainment content; and
initiating displaying of the third infotainment content in association with the sheet of transparent material.

6. The method of claim 5 wherein the requested third infotainment content is displayed without determining a priority level of the requested third infotainment content.

7. The method of claim 1 comprising the further steps of:
receiving a request from a user to display third infotainment content;
ceasing the displaying of the second infotainment content; and
initiating displaying of the third infotainment content in association with the sheet of transparent material.

8. A method of presenting information to passengers within a vehicle having at least one window formed of transparent material in addition to a front windshield, the method comprising the steps of:
receiving:
a user request to present first infotainment content; or
second content related to road conditions or a condition of the vehicle; and
in response to the receiving step, displaying the first infotainment content or the second content on the window or windshield.

9. The method of claim 8 wherein the second content related to road conditions or a condition of the vehicle is received, and the second content is displayed only if a priority level of the second content is higher that a priority level of third content that is being displayed on the window or windshield when the second content is received.

10. The method of claim 8 wherein the transparent material comprises glass.

11. The method of claim 8 wherein the second content is related to driving conditions of the environment in which the vehicle is disposed.

12. The method of claim 8 wherein the user request to present first infotainment content is received, and the first infotainment content is displayed without determining a priority level of the first infotainment content.

13. The method of claim 8 wherein the second content is related to a condition of the vehicle.

14. The method of claim 8 wherein the second content is related to road conditions or a condition of the vehicle is received, the second content being displayed without determining a priority level of the second content if the second content is safety related, and, if the second content is not safety related, then the second content is displayed only if a priority level of the second content is higher that a priority level of third content that is being displayed on the window or windshield when the second content is received.

15. A motor vehicle, comprising:
at least one side view window or windshield including a sheet of transparent material; and
a display control unit configured to present at least one image on the window or windshield, the display control unit including a processor configured to:
cause the display control unit to display first infotainment content on the window, the first infotainment content having a first priority level;
determine whether a second priority level of second infotainment content is higher than the first priority level;
if the second priority level is higher than the first priority level, then:
cause the display control unit to cease the displaying of the first infotainment content; and
cause the display control unit to initiate displaying of the second infotainment content on the window or windshield; and
if the second priority level is not higher than the first priority level, then cause the display control unit to continue the displaying of the first infotainment content.

16. The vehicle of claim 15 wherein the sheet of transparent material comprises a sheet of glass.

17. The vehicle of claim 15 wherein the wherein the second infotainment content is related to driving conditions of the environment in which the vehicle is disposed.

18. The vehicle of claim 15 wherein the processor is configured to:
receive a request from a user to display third infotainment content;
cease the displaying of the first infotainment content; and
initiate displaying of the third infotainment content on the window or windshield.

19. The vehicle of claim 18 wherein the processor is configured to display the requested third infotainment content without determining a priority level of the requested third infotainment content.

20. The vehicle of claim 15 wherein the processor is configured to:
receive a request from a user to display third infotainment content;
cease the displaying of the second infotainment content; and
initiate displaying of the third infotainment content on the window or windshield.
